(19) United States
(12) Patent Application Publication
(10) Pub. No.: US 2010/0179682 A1
(43) Pub. Date: Jul. 15, 2010

(54) PAPER MONEY PROCESSING APPARATUS

(75) Inventor: Hiroki Hamasaki, Hyogo (JP)

Correspondence Address: FOLEY AND LARDNER LLP;SUITE 500, 3000 K STREET NW, WASHINGTON, DC, 20007, US

(73) Assignee: GLORY LTD.

(21) Appl. No.: 12/601,674

(22) PCT Filed: May 29, 2007
(86) PCT No.: PCT/JP2007/060927

§ 371 Date: Nov. 24, 2009

(51) Int. Cl. G06F 7/00

(52) U.S. Cl. 700/214

(57) ABSTRACT

A banknote handling apparatus includes general-purpose storages that store therein either a banknote or a cash voucher based on a structure capable of storing therein and feeding therefrom both the banknote and the cash voucher, a depositing/dispensing mechanism that holds both the banknote and the cash voucher so that a user can take out the banknote and the cash voucher, a transport path for transporting both the banknote and the cash voucher from the general-purpose storages to the depositing/dispensing mechanism, and a recognition/determination mechanism that recognizes each type of the banknote and the cash voucher fed from the general-purpose storages.

### TECHNICAL FIELD

The present invention relates to a banknote handling apparatus that dispenses a banknote and a cash voucher to a user.

### BACKGROUND ART

Conventionally, there are banknote handling machines (such as an automatic ticket machine and an ATM (Automated Teller Machine) that provides the customers of a financial institution with over-the-counter customer service without a teller) that handle cash and also handle paper sheets including cash vouchers such as gift certificates or discount coupons and including receipts. Such a banknote handling machine is separately provided with a banknote storage for storing therein banknotes and a paper-sheet storage for storing therein paper sheets, so that banknotes and paper sheets are stored in the storages, respectively. When a preset procedure is performed by a user to dispense a banknote for a required amount of money, the banknote handling machine feeds the banknote from the banknote storage and feeds a paper sheet from the paper-sheet storage, and transports both of them to a takeout port through specific transport paths, respectively. There are also some banknote handling machines that transport the banknote and the paper sheet through one transport path. In addition, some of the banknote handling machines are provided with a recognition/determination unit, along the transport path, that determines whether the banknote is genuine or counterfeit, and some of them are provided with both the recognition/determination unit for the banknote and another recognition/determination unit only for cash vouchers that determines whether the cash voucher is genuine or counterfeit. After it is determined whether the banknote and the cash voucher are genuine or counterfeit, the genuine note and the counterfeit note are separately processed. In a retail industry such as supermarkets and retailers, some of the banknote handling machines are used by being connected to a POS (Point of Sales System) register.

For example, Patent Document 1 discloses a multipurpose banknote dispenser that is provided with a storage only for coupons and with a storage only for receipts in addition to a storage only for banknotes, and that dispenses a banknote for a predetermined amount of money and also issues a coupon and a receipt. In addition, as an example of separately providing a banknote storage for storing therein banknotes and a paper-sheet storage for storing therein paper sheets, Patent Document 2 discloses an automatic change dispenser that handles, when a cash voucher such as a gift certificate and a discount coupon is taken thereinto, the money amount of the cash voucher equivalently to the money amount of the banknote, but stores the taken-in cash voucher in a particular storage.

Patent Document 1: Japanese Patent Application Laid-open No. 2003-168144

Patent Document 2: Japanese Patent Application Laid-open No. 2007-34523

### DISCLOSURE OF INVENTION

### Problem to be Solved by the Invention

However, the conventional technologies have problems that the cost for its manufacture is increased and the size of the device is increased more than necessary. Namely, because it is necessary to provide a storage, a transport path, and a recognition/determination unit only for cash vouchers, separately from those for banknotes, there remain problems that the cost for its manufacture is increased and the size of the device is increased more than necessary.

The conventional technologies also have a problem that the devices cannot flexibly deal with changes to the specification. More specifically, if handling of cash vouchers that is continuously performed until then is stopped for some reasons, the mechanism and the space provided for handling cash vouchers in the device will be wasted unless uses of the storage, the transport path, and the recognition/determination unit, all of which are provided only for cash vouchers, are changed to uses of those for banknotes. Meanwhile, if a modification is provided to a device that handles only banknotes so as to enable the device to handle also cash vouchers, it is necessary to install a new storage only for cash vouchers. As can be seen, the conventional technologies cannot flexibly deal with the changes to the specification.

The present invention has been therefore made to solve some problems based on the conventional technologies, and it is an object of the present invention to provide a banknote handling apparatus capable of reducing the cost of its manufacture, making the size compact, and capable of flexibly dealing with changes to specification.

### Means for Solving Problem

To solve the problems described above and achieve the object, the invention as set forth in claim 1 is a banknote handling apparatus for dispensing a banknote and dispensing a cash voucher to a user. The banknote handling apparatus includes a plurality of storages that has a structure capable of storing therein and feeding therefrom both the banknote and the cash voucher, and stores therein either the banknote or the cash voucher, respectively; a cash-voucher-setting-information storage unit that accepts and stores therein cash-voucher setting information indicating in which of the plurality of storages the cash voucher is stored; a holding unit for take-out that holds the cash voucher so that the user can take out the cash voucher therefrom; a transport unit that transports both the banknote and the cash voucher from the plurality of storages to the holding unit for take-out; a recognition unit that recognizes each type of the banknote and the cash voucher fed from the plurality of storages; and a control unit that controls the respective units so that any one of the storages corresponding to the cash-voucher setting information stored in the cash-voucher-setting-information storage unit feeds a cash voucher when the cash voucher is to be dispensed, the transport unit transports the cash voucher while the recognition unit recognizes the cash voucher, and the holding unit for take-out holds the cash voucher.

In the invention as set forth in claim 2, the holding unit for take-out holds both the banknote and the cash voucher so that the user can take out the banknote and the cash voucher, and the control unit controls, when the cash voucher is to be dispensed together with the banknote, the holding unit for take-out so as to hold the cash voucher together with the banknote.

The invention as set forth in claim 3 further includes a transport-setting-information storage unit that accepts and stores therein transport setting information indicating which of the banknote and the cash voucher is transported first to the holding unit for take-out when the cash voucher is to be dispensed together with the banknote. The control unit controls, when the cash voucher is to be dispensed together with the banknote, the transport unit so as to first transport either the banknote or the cash voucher to the holding unit for take-out according to the transport setting information stored in the transport-setting-information storage unit.

The invention as set forth in claim 4 further includes a recognition-setting-information storage unit that accepts and stores therein recognition setting information indicating whether a recognition function performed by the recognition unit is enabled or disabled when the cash voucher is to be dispensed. The control unit controls the recognition unit so as to recognize a cash voucher fed by the storage if the recognition setting information indicating that the recognition function is enabled is stored by the recognition-setting-information storage unit.

The invention as set forth in claim 5 further includes a feature-quantity storage unit that stores therein each feature quantity of the banknote and the cash voucher stored in the plurality of storage unit respectively. The recognition unit checks a feature quantity of an object fed from the storage against the feature quantity stored in the feature-quantity storage unit, and recognizes whether the object fed from the storage is the banknote, the cash voucher, or anything other than these.

The invention as set forth in claim 6 further includes a money-amount-information storage unit that stores therein an amount of cash voucher to be dispensed together with a banknote, corresponding to a money amount of the banknote to be dispensed to the user. The control unit controls, when the cash voucher is to be dispensed together with the banknote, the storage so as to read the amount of the cash voucher corresponding to the money amount of the banknote from the money-amount-information storage unit, and feeds the cash voucher corresponding to the money amount.

In the invention as set forth in claim 7, the transport path transports the banknote and the cash voucher from the plurality of storages to the holding unit for take-out and also transports both of them from the holding unit for take-out to the plurality of storages, and the control unit controls, when cash vouchers for replenishment are held by the holding unit for take-out, the transport unit so as to transport the cash vouchers for replenishment to the storage corresponding to the cash-voucher setting information stored in the cash-voucher-setting-information storage unit.

In the invention as set forth in claim 8, the storage is removably attached to the banknote handling apparatus, so that cash vouchers for replenishment are received and stored in the storage when the storage is removed from the banknote handling apparatus.

### Effect of the Invention

According to the invention as set forth in claim 1, there are provided the plurality of storages that has the structure capable of storing therein and feeding therefrom both the banknote and the cash voucher and therefore stores therein either one of the banknote or the cash voucher respectively; a takeout port that holds the cash voucher so that the user can take out the cash voucher; the transport path for transporting both the banknote and the cash voucher from the plurality of storages to the takeout port; and the recognition unit that recognizes each type of both the banknote and the cash voucher fed from the storages. The cash-voucher setting information indicating in which of the plurality of storages the cash voucher is stored is accepted and stored. When the cash voucher is to be dispensed, the relevant components are controlled so that the storage corresponding to the stored cash-voucher setting information feeds the cash voucher, the transport path transports the cash voucher while being recognized by the recognition unit, and the takeout port holds the cash voucher. Thus, the cost of its manufacture can be reduced and the size can be made compact, and the changes to specification can also be flexibly dealt with. More specifically, there is no need to provide the storage only for cash vouchers, the recognition/determination mechanism only for cash vouchers, or the transport path only for cash vouchers, and thus, each of the components can be formed with necessary minimum units, which enables its manufacturing cost to be reduced and the size to be made compact. Furthermore, by only setting the storage as one only for cash vouchers, the components are controlled so that the banknote and the cash voucher are recognized as the banknote and as the cash voucher respectively by the same recognition/determination mechanism while being transported through the same transport path, so that it is possible to flexibly deal with the case in which the cash voucher is newly handled. In addition, when the handling of the cash voucher is stopped, the setting of the storage only for cash vouchers is simply released, thus, flexibly dealing with this case.

According to the invention as set forth in claim 2, the takeout port holds both the banknote and the cash voucher so that the user can take out the banknote and the cash voucher therefrom. When the banknote and the cash voucher are to be dispensed, the takeout port is controlled so as to hold the cash voucher together with the banknote. With these operations, it is possible to prevent the user from forgetting to take out the cash voucher. In other words, it is possible to prevent a case in which, for example, when the banknote is first dispensed, the user may take out only the banknote and forget to take out the cash voucher dispensed afterward without noticing the cash voucher.

According to the invention as set froth in claim 3, when the cash voucher is to be dispensed together with the banknote, the transport setting information indicating which of the banknote and the cash voucher is to be first transported to the takeout port is accepted and stored. When the cash voucher is to be dispensed together with the banknote, the transport path is controlled according to the stored transport setting information so as to first transport either one of the banknote and the cash voucher to the takeout port. Therefore, for example, by placing the cash voucher on a bundle of banknotes, this enables the user to see the cash voucher first.

According to the invention as set forth in claim 4, when the cash voucher is to be dispensed, the recognition setting information indicating whether the recognition function performed by the recognition unit is enabled or disabled is accepted and stored. The recognition unit is controlled so as to recognize the cash voucher fed by the storage only when the setting information indicating the recognition function is enabled is stored. Therefore, it is possible to dispense the banknote and the cash voucher by reducing the processing time by the time consumed for recognition of the cash voucher.

According to the invention as set forth in claim 5, the feature quantities of banknotes and cash vouchers respectively stored in the plurality of storages are stored, a feature quantity of an object to be fed from the storage is checked against the stored feature quantity, and it is recognized whether the object fed from the storage is the banknote, the cash voucher, or anything other than these, which allows commonality of a recognition method between the banknote and the cash voucher, thus avoiding the recognition process from being complicated.

According to the invention as set forth in claim 6, the amount of the cash voucher to be dispensed together with a banknote is stored, corresponding to the money amount of the banknote to be dispensed to the user. When the cash voucher is to be dispensed together with the banknote, the amount of the cash voucher corresponding to the money amount of the banknote is read from the stored correspondence relation, and the cash voucher for the corresponding money amount is fed out. Therefore, for example, the user who takes an amount of more money out of the apparatus can take out more cash vouchers.

According to the invention as set forth in claim 7, the transport path transports the banknote and the cash voucher from the plurality of storages to the takeout port and also transports them from the takeout port to the plurality of storages. When cash vouchers for replenishment are held in the takeout port, the transport path transports the cash vouchers for replenishment to the storage set as a storage only for cash vouchers. With these processes, the cash vouchers can be replenished with a simple operation as compared with a method for removing the storage and replenishing the cash vouchers into it.

According to the invention as set forth in claim 8, the storage is removably attached to the banknote handling apparatus, so that the cash vouchers for replenishment are stored in the storage when the storage is removed from the banknote handling apparatus. Therefore, the cash vouchers can be surely replenished as compared with a method for replenishing the cash vouchers through the takeout port.

### BRIEF DESCRIPTION OF DRAWINGS

FIG. 1 is a diagram illustrating an overview and features of a banknote handling apparatus according to a first embodiment of the present invention.

FIG. 2 is a block diagram of a configuration of the banknote handling apparatus according to the first embodiment.

FIG. 3 is a diagram representing an example of an image displayed on the screen of an output unit.

FIG. 4 is a diagram representing an example of information stored by a determination-condition storage unit.

FIG. 5 is a diagram representing an example of information stored by a recognition/determination reference storage unit.

FIG. 6 is a diagram representing an example of information stored by a stored paper-sheet-table storage unit.

FIG. 7 is a flowchart representing a process flow upon payment of money in the banknote handling apparatus.

FIG. 8 is a flowchart representing a process flow related to setting of a general-purpose storage.

FIG. 9 is a diagram representing an example of an image displayed on the screen of the output unit when setting for a dispensing order is accepted.

FIG. 10 is a diagram representing an example of an image displayed on the screen of the output unit when setting for an object to be recognized is accepted.

### EXPLANATIONS OF LETTERS OR NUMERALS

2 Table

10 Banknote handling apparatus

20 Upper unit

21 Inlet/Outlet

22 Depositing/dispensing mechanism

23 Recognition/determination mechanism

24 Escrow unit

25 Temporary stacking unit

30 Lower unit

31 Collection storage

32a to 32e General-purpose storage

40 Transport path

50 Input unit

60 Output unit

70 Storage unit

71 Determination-condition storage unit

72 Recognition/determination reference storage unit

73 Stored paper-sheet-table storage unit

80 Control unit

81 Cash-voucher dispensed-amount determining unit

82 Transport controller

83 Stacked-money-amount calculator

84 Recognition/determination mechanism controller

85 Storage setting processor

### BEST MODE(S) FOR CARRYING OUT THE INVENTION

Embodiments of the banknote handling apparatus according to the present invention will be explained in detail below with reference to accompanying drawings. It should be noted that in the followings, explanation of the terms, the overview and features of the banknote handling apparatus according to the present invention, the configuration of the banknote handling apparatus, and a process flow of the banknote handling apparatus are sequentially explained, effect of a first embodiment of the present invention is explained, and then, other embodiments will be explained.

### First Embodiment

Explanation of Terms

First, the main terms used in the following embodiments are explained. A term of “banknote (corresponding to “banknote” according to claims of the present invention)” represents paper currency, for example, Bank of Japan notes such as a 1000-yen note, a 5000-yen note, and a 10000-yen note, and US one-dollar bill and five-dollar bill. A term of “cash voucher (corresponding to “cash voucher” according to the claims)” represents a voucher in which a value equivalent to its stated value is authorized within a specific range, and includes, for example, a gift certificate, a coupon, and a discount coupon.

Overview and Features of Banknote Processing Apparatus

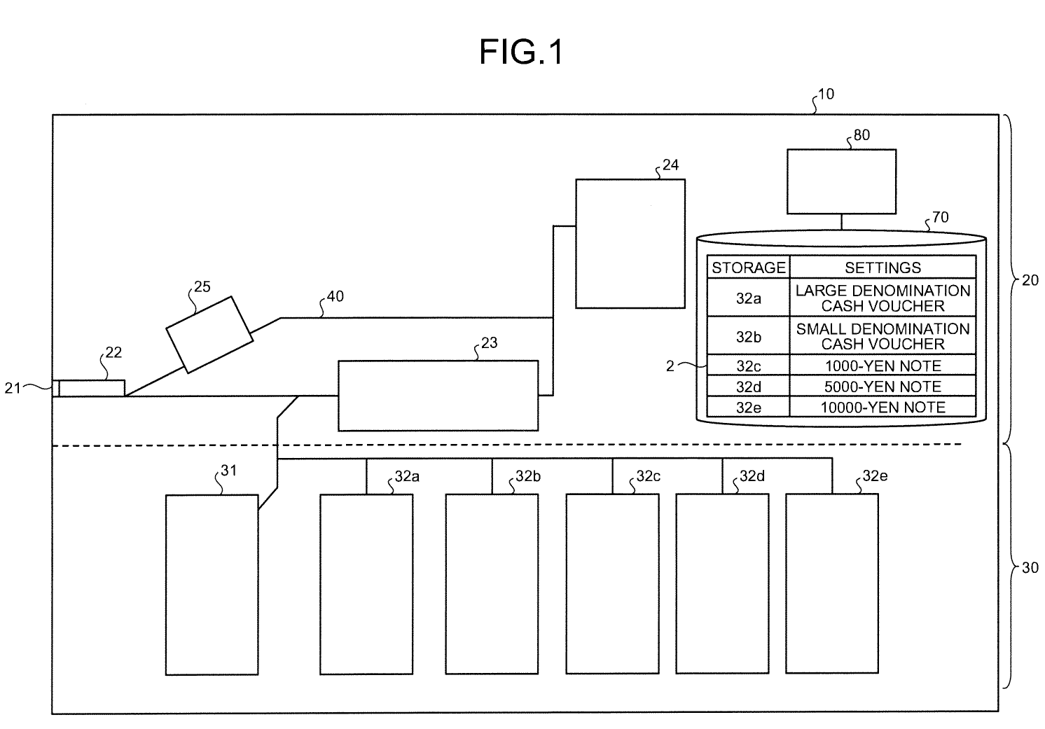

Next, the overview and features of a banknote handling apparatus according to the first embodiment is explained below with reference to FIG. 1. FIG. 1 is a diagram illustrating the overview and the features of the banknote handling apparatus according to the first embodiment. As shown in this figure, a banknote handling apparatus 10 includes an upper unit 20 and a lower unit 30. The upper unit 20 includes an inlet/outlet 21, a depositing/dispensing mechanism 22, a recognition/determination mechanism 23, an escrow unit 24, and a temporary stacking unit 25, and the lower unit 30 includes a collection storage 31 and general-purpose storages 32a to 32e, which communicate each other through a transport path 40. The banknote handling apparatus 10 mainly dispenses a banknote and a cash voucher to a user, and has main features in which it is possible to make the manufacturing cost low, make the size compact, and flexibly deal with changes to specification.

More specifically, as shown in FIG. 1, because the general-purpose storages 32a to 32e have a structure capable of storing therein both the banknote and the cash voucher and feeding the stored one, each of them stores therein either the banknote or the cash voucher. A storage unit 70 accepts and stores therein cash-voucher setting information indicating in which of the general-purpose storages 32a to 32e the cash voucher is stored (see Table 2), and the depositing/dispensing mechanism 22 holds both the banknote and the cash voucher so that the user can take out the banknote and the cash voucher. The transport path 40 transports both the banknote and the cash voucher from the general-purpose storages 32a to 32e to the depositing/dispensing mechanism 22, and the recognition/determination mechanism 23 recognizes each type of the banknotes and the cash vouchers fed from the general-purpose storages 32a to 32e. When the cash voucher is to be dispensed together with the banknote, a control unit 80 controls relevant components so that any one of the general-purpose storages 32a to 32e corresponding to the cash-voucher setting information stored in the storage unit 70 feeds the cash voucher, the transport path 40 transports the cash voucher while being recognized by the recognition/determination mechanism 23, and the depositing/dispensing mechanism 22 holds the cash voucher together with the banknote.

By doing so, the banknote handling apparatus according to the first embodiment can make the manufacturing cost low, make the size thereof compact, and flexibly deal with the changes to the specification. In other words, there is no need to provide the storage only for cash vouchers, the recognition/determination mechanism only for cash vouchers, or the transport path only for cash vouchers respectively, and each of the components can be formed with necessary minimum units. Therefore, it is possible to reduce the manufacturing cost and make the size compact. Furthermore, by only setting a storage to that only for cash vouchers, it is controlled so that the banknote and the cash voucher are recognized as the banknote and as the cash voucher respectively by the same recognition/determination mechanism while being transported through the same transport path. Accordingly, the banknote handling apparatus can flexibly deal with a case of newly handling also cash vouchers. In a case in which the handling of the cash vouchers is stopped, the setting of the storage as one only for cash vouchers is simply released, and thus, the banknote handling apparatus can flexibly deal with this case.

Configuration of Banknote Processing Apparatus

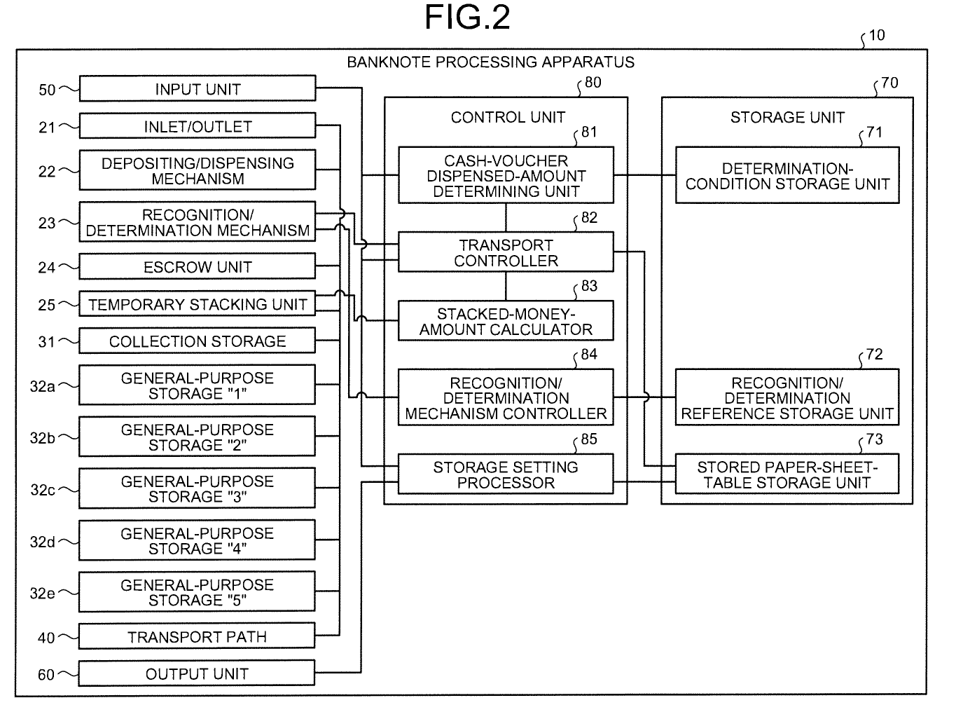

Next, the configuration of the banknote handling apparatus 10 is explained with reference to FIG. 2. FIG. 2 is a block diagram of the configuration of the banknote handling apparatus 10. As shown in this figure, the banknote handling apparatus 10 includes the inlet/outlet 21, the depositing/dispensing mechanism 22, the recognition/determination mechanism 23, the escrow unit 24, the temporary stacking unit 25, the collection storage 31, the general-purpose storages 32a to 32e, the transport path 40, an input unit 50, an output unit 60, the storage unit 70, and the control unit 80.

The general-purpose storages 32a to 32e have a structure capable of storing therein and feeding therefrom both banknotes and cash vouchers, so that each of the general-purpose storages 32a to 32e stores therein either the banknote or the cash voucher. A specific example thereof is explained below. In the first embodiment, a general-purpose storage 32a “1” stores therein large denomination cash vouchers, a general-purpose storage 32b “2” stores therein small denomination cash vouchers, a general-purpose storage 32c “3” stores therein 1000-yen notes, a general-purpose storage 32d “4” stores therein 5000-yen notes, and a general-purpose storage 32e “5” stores therein 10000-yen notes. The general-purpose storages 32a to 32e feed a relevant cash voucher or banknote to the transport path 40 under control by the control unit 80. Depending on settings, for example, the general-purpose storage 32a can also store therein banknotes and feed a relevant banknote to the transport path 40 under control by the control unit 80. In the banknote handling apparatus 10, pieces of storage identification information are associated with the general-purpose storages 32a to 32e so as to uniquely identify the general-purpose storages 32a to 32e respectively, and, for example, storage identification information “1” is associated with the general-purpose storage 32a.

The transport path 40 transports both the banknote and the cash voucher from the general-purpose storages 32a to 32e to the depositing/dispensing mechanism 22. More specifically, the transport path 40 transports the banknote and the cash voucher fed from the general-purpose storages 32a to 32e to the components (such as the recognition/determination mechanism 23 and the temporary stacking unit 25) under control by the control unit 80, to finally transport them to the depositing/dispensing mechanism 22. Both the banknote and the cash voucher are placed on the same belt and transported.

The recognition/determination mechanism 23 recognizes each type of all the banknotes and the cash vouchers fed from the general-purpose storages 32a to 32e. More specifically, when receiving a banknote or a paper sheet such as a cash voucher, the recognition/determination mechanism 23 executes predetermined measurement to the paper sheet under control by the control unit 80 to obtain a feature quantity of the paper sheet, and recognizes the paper sheet based on the obtained feature quantity. The banknote and the cash voucher are determined as two types: authenticated ones as genuine and anything other than the authenticated ones within a range of the recognition capability of the recognition/determination mechanism 23. In the followings, the former is called “genuine note”, and the latter is called “rejected note”.

The depositing/dispensing mechanism 22 holds both the banknote and the cash voucher so that the user can take out the banknote and the cash voucher. More specifically, the depositing/dispensing mechanism 22 holds the banknotes or the paper sheets as cash vouchers in the same space without being separated from each other so as to be superimposed on each other.

The escrow unit 24 temporarily holds the banknote and the cash voucher determined as the rejected notes as a result of recognition, and the temporary stacking unit 25 temporarily stacks the banknote and the cash voucher determined as the genuine notes as the result of recognition. The collection storage 31 stores therein the banknote and the cash voucher transported from the escrow unit 24 and determined as the rejected notes as the result of recognition. The inlet/outlet 21 includes an openable/closeable shutter, and opens/closes the shutter under control by the control unit 80.

The input unit 50 is formed with a touch panel or the like provided on the outer surface of the apparatus, and accepts a dispensed amount from the user and inputs the amount to the control unit 80. More specifically, when accepting a predetermined dispensed amount input by the user through the touch panel, the input unit 50 outputs information for the dispensed amount to a cash-voucher dispensed-amount determining unit 81 and to a transport controller 82 which are explained later. For example, when accepting a dispensed amount of 36000 yen, the input unit 50 outputs information “36000” as the dispensed amount to the cash-voucher dispensed-amount determining unit 81 and to the transport controller 82.

Moreover, the input unit 50 accepts a change of the cash-voucher setting information and inputs the change to the control unit 80. More specifically, when accepting a change request for setting of the general-purpose storages 32a to 32e input by a manager through the touch panel, the input unit 50 outputs the change request to a storage setting processor 85 explained later. Furthermore, when accepting a change instruction for setting of the general-purpose storages 32a to 32e input by the manager through the touch panel, the input unit 50 outputs setting information according to the change instruction for the setting to the storage setting processor 85.

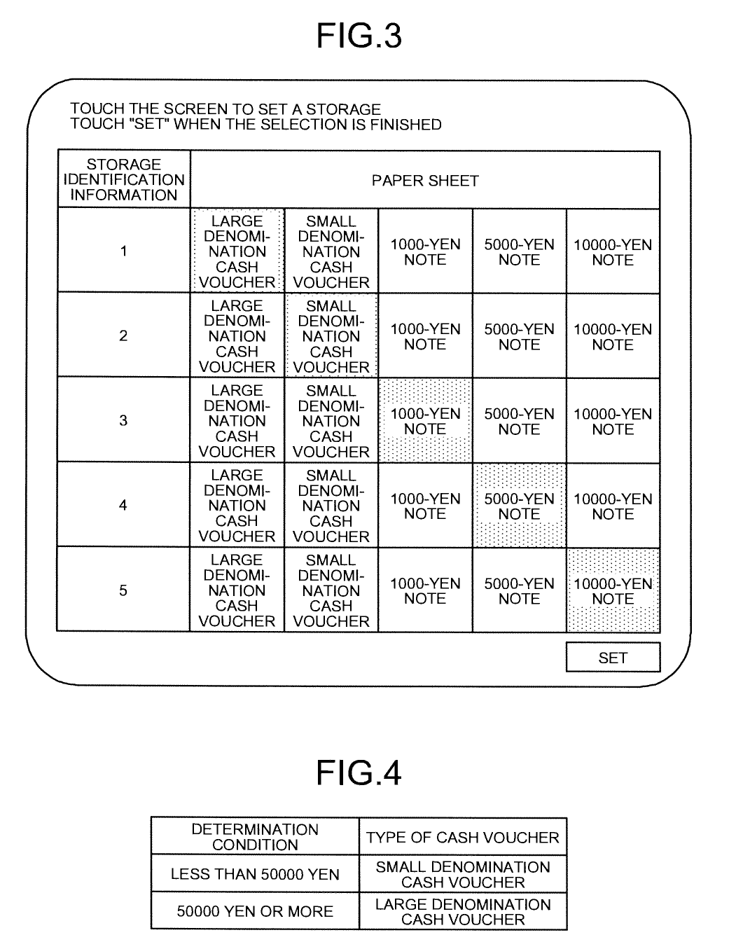

The output unit 60 is formed with a touch panel or the like provided on the outer surface of the apparatus, and displays a predetermined image on the screen. More specifically, when receiving information for generating an image from the storage setting processor 85 explained later, the output unit 60 displays the image on the screen of the touch panel based on the information (see FIG. 3). The input unit 50 accepts the change instruction for setting of the general-purpose storages 32a to 32e input by the manager through the surface of the touch panel while viewing the screen as shown in FIG. 3. FIG. 3 is a diagram representing an example of an image displayed on the screen of the output unit.

The storage unit 70 stores therein data used for various processes performed by the control unit 80, and includes a determination-condition storage unit 71, a recognition/determination reference storage unit 72, and a stored paper-sheet-table storage unit 73 as particularly closely related to the present invention. The stored paper-sheet-table storage unit 73 corresponds to “cash-voucher-setting-information storage unit” according to the claims, the recognition/determination reference storage unit 72 corresponds to “feature-quantity storage unit” according to one of the claims, and the determination-condition storage unit 71 corresponds to “money-amount-information storage unit” according to one of the claims.

The determination-condition storage unit 71 stores therein an amount of cash voucher to be dispensed together with a banknote, corresponding to the money amount of the banknote to be dispensed to the user. More specifically, as shown in FIG. 4, the determination-condition storage unit 71 stores therein a determination condition indicating a range of the money amount of banknotes associated with a type of cash voucher indicating a fixed amount of cash voucher. For example, as shown in FIG. 4, the determination-condition storage unit 71 stores therein “less than 50000-yen” as a determination condition associated with “small denomination cash voucher” as a type of cash voucher (for example, the type may be set to 1000 yen as a large denomination cash voucher and 100 yen as a small denomination cash voucher). FIG. 4 is a diagram representing an example of information stored by the determination-condition storage unit.

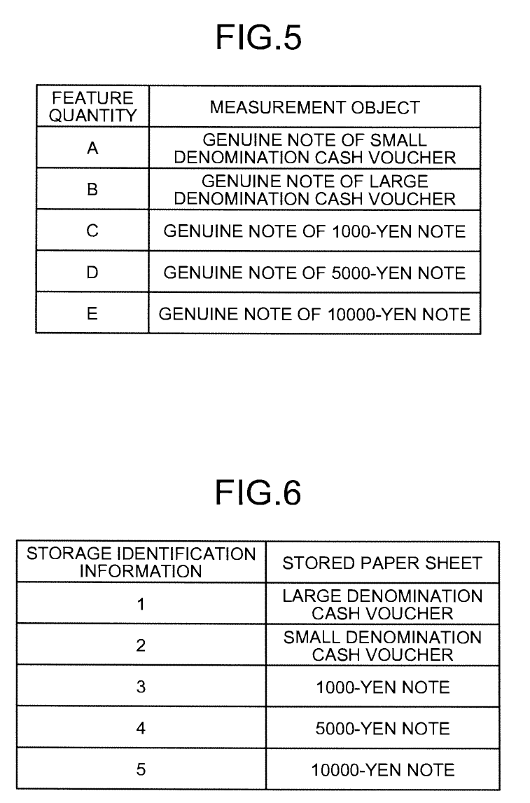

The recognition/determination reference storage unit 72 stores therein feature quantities of banknotes and cash vouchers to be stored in the general-purpose storages, respectively. More specifically, as shown in FIG. 5, the recognition/determination reference storage unit 72 stores therein a feature quantity being values which are obtained by measuring the banknote or the cash voucher and indicate a feature of the banknote or the cash voucher in association with a measurement object. For example, as shown in FIG. 5, the recognition/determination reference storage unit 72 stores therein a reference value “C” of an attenuation of infrared rays in beams passing through a genuine note of 1000-yen note associated with “genuine note of 1000-yen note” as a measurement object. FIG. 5 is a diagram representing an example of information stored by the recognition/determination reference storage unit.

The stored paper-sheet-table storage unit 73 accepts and stores therein cash-voucher setting information indicating in which of the general-purpose storages a cash voucher is stored. More specifically, as shown in FIG. 6, the stored paper-sheet-table storage unit 73 stores therein information indicating whether each of the general-purpose storages provided in the apparatus stores therein a cash voucher or a banknote and indicating which of denominations is to be stored if the banknote is stored therein, in association with each other in each of the general-purpose storages. For example, as shown in FIG. 6, the stored paper-sheet-table storage unit 73 stores therein “large denomination cash voucher”, “small denomination cash voucher”, “1000-yen note”, “5000-yen note”, and “10000-yen note” in association with the general-purpose storage “1” to the general-purpose storage “5”, respectively. The general-purpose storages 32a to 32e are associated with identification information with which they can be uniformly identified respectively. FIG. 6 is a diagram representing an example of information stored by the stored paper-sheet-table storage unit.

The control unit 80 is a processor that includes an internal memory that stores therein programs and control data defining various procedures and thereby executes various processes. The control unit 80 includes the cash-voucher dispensed-amount determining unit 81, the transport controller 82, a stacked-money-amount calculator 83, a recognition/determination mechanism controller 84, and the storage setting processor 85, which are particularly closely related to the present invention. It should be noted that the transport controller 82 corresponds to “control unit” according to the claims, and the recognition/determination mechanism controller 84 corresponds to “recognition unit” according to the claims.

The cash-voucher dispensed-amount determining unit 81 determines a money amount of cash voucher to be dispensed according to a dispensed amount. More specifically, the cash-voucher dispensed-amount determining unit 81 receives information for the dispensed amount from the input unit 50, reads a type of the cash voucher from the correspondence relation stored by the determination-condition storage unit 71, and outputs the information for the type of the cash voucher to the transport controller 82, explained later. For example, when receiving information “36000” as the dispensed amount from the input unit 50, the cash-voucher dispensed-amount determining unit 81 reads “small denomination cash voucher” associated with “less than 50000 yen” (see FIG. 4). The cash-voucher dispensed-amount determining unit 81 outputs the information “small denomination cash voucher” as the type of the cash voucher to the transport controller 82.

When the cash voucher is to be dispensed, the transport controller 82 controls relevant components in the following manner. The general-purpose storage that stores therein cash vouchers feeds a cash voucher based on the cash-voucher setting information stored in the stored paper-sheet-table storage unit 73, the transport path 40 transports the cash voucher while being recognized by the recognition/determination mechanism 23, and the depositing/dispensing mechanism 22 holds the cash voucher. When a banknote and a cash voucher are to be dispensed, the transport controller 82 controls the depositing/dispensing mechanism 22 so as to hold the cash voucher together with the banknote. In addition, when a banknote and a cash voucher are to be dispensed, the transport controller 82 reads the amount of cash voucher corresponding to the money amount of the banknote from the determination-condition storage unit 71, and controls the general-purpose storage so as to feed the cash voucher corresponding to the money amount.

More specifically, when receiving the information for the type of cash voucher from the cash-voucher dispensed-amount determining unit 81, the transport controller 82 refers to the stored paper-sheet-table storage unit 73, to read storage identification information associated with the type of the cash voucher. The transport controller 82 controls the general-purpose storage corresponding to the read storage identification information so as to feed the cash voucher to the transport path 40. The transport controller 82 outputs a signal indicating a start of control for the recognition/determination mechanism 23 to the recognition/determination mechanism controller 84, explained later. When receiving a determination result indicating that the cash voucher is the genuine note from the recognition/determination mechanism controller 84, the transport controller 82 controls the transport path 40 so as to transport the cash voucher to the temporary stacking unit 25. Meanwhile, when receiving a determination result indicating that the cash voucher is the rejected note from the recognition/determination mechanism controller 84, the transport controller 82 controls the transport path 40 so as to transport the cash voucher to the escrow unit 24.

When receiving a signal indicating transport of a banknote from the stacked-money-amount calculator 83, explained later, the transport controller 82 determines a denomination of the banknote and the number of banknotes to be fed based on the information for the dispensed amount already received from the input unit 50. The transport controller 82 reads storage identification information associated with the denomination of the banknote by referring to the stored paper-sheet-table storage unit 73. The transport controller 82 controls the general-purpose storage corresponding to the read storage identification information so as to feed a required number of banknotes to the transport path 40. The transport controller 82 outputs a signal indicating a start of control for the recognition/determination mechanism 23 to the recognition/determination mechanism controller 84, explained later. When receiving a determination result indicating that the banknote is the genuine note from the recognition/determination mechanism controller 84, the transport controller 82 controls the transport path 40 so as to transport the banknote to the temporary stacking unit 25. Meanwhile, when receiving a determination result indicating that the banknote is the rejected note, the transport controller 82 controls the transport path 40 so as to transport the banknote to the escrow unit 24. When receiving information for a total money amount of currently stacked banknotes from the stacked-money-amount calculator 83, the transport controller 82 checks the received information against the information for the dispensed amount received from the input unit 50. If both the amounts match each other, the transport controller 82 controls the temporary stacking unit 25 to feed the banknote and the cash voucher to the transport path 40. The transport controller 82 controls the transport path 40 to transport the banknote to the depositing/dispensing mechanism 22, and controls the inlet/outlet 21 so as to open the shutter. If both the amounts do not match each other as a result of the checking, the transport controller 82 controls the components in the above manner so that the banknote for an insufficient amount of money is transported to the temporary stacking unit 25.

The stacked-money-amount calculator 83 monitors the temporary stacking unit 25 and performs a process according to stacked paper sheets. More specifically, when cash vouchers are stacked in the temporary stacking unit 25, the stacked-money-amount calculator 83 outputs a signal indicating transport of the banknote to the transport controller 82. Further, when a last banknote is stacked in the temporary stacking unit 25, the stacked-money-amount calculator 83 calculates a total amount of money and outputs information indicating the calculated total amount of money to the transport controller 82.

The recognition/determination mechanism controller 84 checks the feature quantity of an object fed from the general-purpose storage against the feature quantity stored in the recognition/determination reference storage unit 72, and recognizes whether the object fed from the general-purpose storage is the banknote, the cash voucher, or anything other than these. More specifically, when receiving the signal indicating the start of control for the recognition/determination mechanism 23 from the transport controller 82, the recognition/determination mechanism controller 84 controls the recognition/determination mechanism 23 to measure a feature quantity of one (a banknote or a cash voucher) currently transported to the recognition/determination mechanism 23. The recognition/determination mechanism controller 84 determines whether the banknote or the cash voucher is the genuine note or the rejected note by referring to the recognition/determination reference storage unit 72, and outputs the result of determination to the transport controller 82. For example, when acquiring the feature quantity “A” as the result of measurement, the recognition/determination mechanism controller 84 refers to the recognition/determination reference storage unit 72, and outputs the result of determination indicating that the banknote or the cash voucher is the genuine note to the transport controller 82 (see FIG. 5).

The storage setting processor 85 sets a storage of the cash voucher to any one of the general-purpose storages 32a to 32e. More specifically, when receiving a change request output from the input unit 50 when the input unit 50 accepts the change request for setting of any one of the general-purpose storages 32a to 32e, the storage setting processor 85 outputs information for generating an image to the output unit 60. The storage setting processor 85 receives setting information output from the input unit 50 to which the setting information is input by the manager through the touch panel provided on the outer surface of the apparatus while referring to the image displayed on the screen of the output unit 60 (see FIG. 3), and updates the stored paper-sheet-table storage unit 73 based on the received setting information. For example, in FIG. 3, if the touch panel is touched at positions of the storage identification information: “2” and the paper sheet: “10000-yen note”, then the storage setting processor 85 receives the setting information for changing the general-purpose storage 32b “2” in such a manner that the storage with the small denomination cash voucher originally stored therein is changed to the storage with 10000-yen note to be stored therein. The storage setting processor 85 updates the stored paper sheet “genuine note of the small denomination cash voucher”, which corresponds to the storage identification information “2” in the stored paper-sheet-table storage unit 73, to a stored paper sheet “genuine note of 10000-yen note” based on the received setting information. It is also possible to set all the general-purpose storages 32a to 32e as the storages for storing therein banknotes in this manner.

Processes of Banknote Processing Apparatus

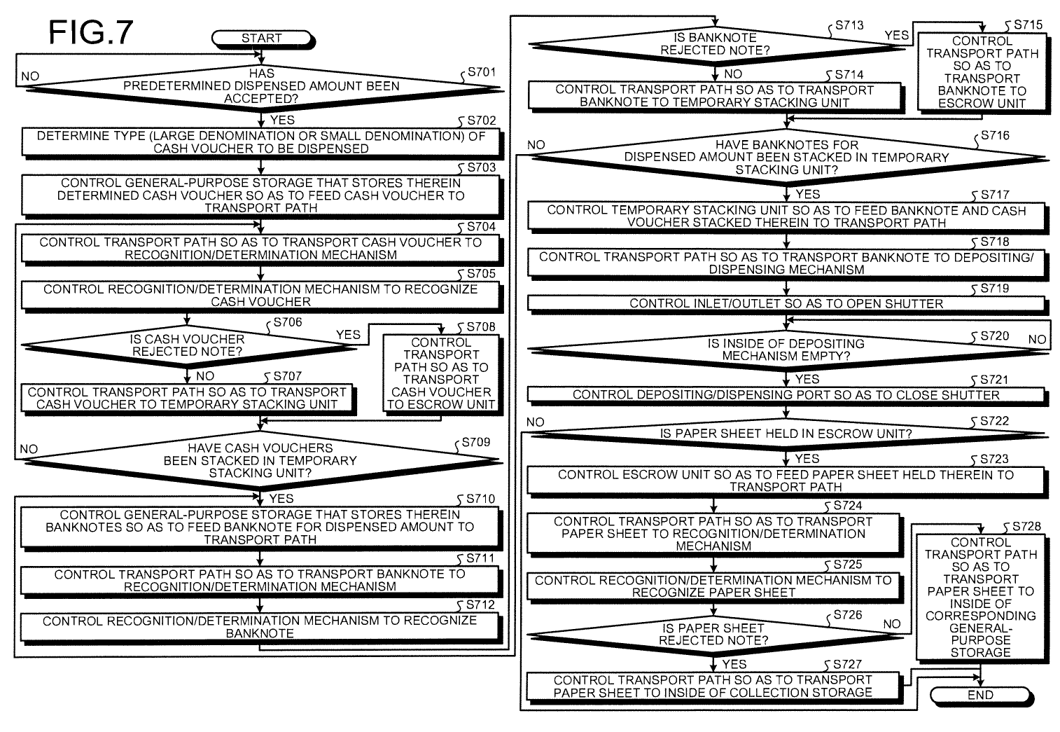

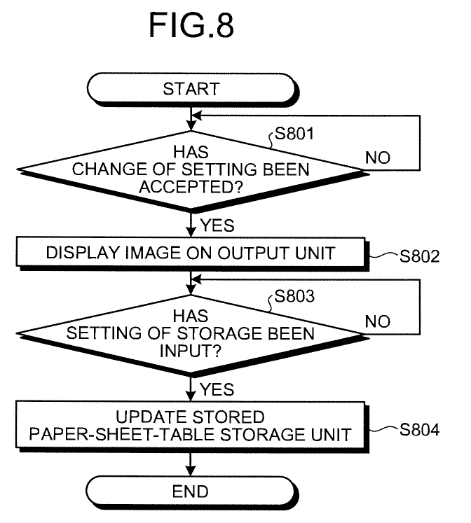

Next, processes of the banknote handling apparatus 10 are explained with reference to FIG. 7 and FIG. 8. FIG. 7 is a flowchart representing a process flow upon payment of money in the banknote handling apparatus, and FIG. 8 is a flowchart representing a process flow related to setting of the general-purpose storage.

As shown in FIG. 7, when the input unit 50 accepts a predetermined dispensed amount (YES at Step S701), the banknote handling apparatus 10 causes the cash-voucher dispensed-amount determining unit 81 to determine a type of cash voucher to be dispensed (Step S702). The banknote handling apparatus 10 causes the transport controller 82 to control the general-purpose storage that stores therein the determined cash voucher so as to feed the cash voucher to the transport path 40 (Step S703), and to control the transport path 40 so as to transport the fed cash voucher to the recognition/determination mechanism 23 (Step S704).

The banknote handling apparatus 10 causes the recognition/determination mechanism controller 84 to control the recognition/determination mechanism 23 to recognize the cash voucher (Step S705). If the cash voucher is the genuine note (NO at Step S706), the transport controller 82 is caused to control the transport path 40 so as to transport the cash voucher to the temporary stacking unit 25 (Step S707). If the cash voucher is the rejected note as a result of recognition (YES at Step S706), the banknote handling apparatus 10 causes the transport controller 82 to control the transport path 40 so as to transport the cash voucher to the escrow unit 24 (Step S708).

When the cash vouchers are stacked in the temporary stacking unit 25 and a signal indicating transport of a banknote is thereby output from the stacked-money-amount calculator 83 to the transport controller 82 (YES at Step S709), the banknote handling apparatus 10 causes the transport controller 82 to control the general-purpose storage for storing therein the banknotes so as to feed the banknote for a dispensed amount to the transport path 40 (Step S710). The banknote handling apparatus 10 causes the transport controller 82 to control the transport path 40 so as to transport the banknote to the recognition/determination mechanism 23 (Step S711).

The banknote handling apparatus 10 causes the recognition/determination mechanism controller 84 to control the recognition/determination mechanism 23 to recognize the banknote (Step S712). If the banknote is the genuine note (NO at Step S713), the transport controller 82 is caused to control the transport path 40 so as to transport the banknote to the temporary stacking unit 25 (Step S714). If the banknote is the rejected note as a result of recognition (YES at Step S713), the banknote handling apparatus 10 causes the transport controller 82 to control the transport path 40 so as to transport the banknote to the escrow unit 24 (Step S715).

When the banknotes for a dispensed amount are stacked in the temporary stacking unit 25 or when, as a result of checking by the transport controller 82 (as a result of checking information for a total amount of money output from the stacked-money-amount calculator 83 to the transport controller 82 against information for the dispensed amount output from the input unit 50 to the transport controller 82), both the pieces of information match each other (YES at Step S716), the banknote handling apparatus 10 causes the transport controller 82 to control the temporary stacking unit 25 so as to feed the banknote and the cash voucher to the transport path 40 (Step S717). The banknote handling apparatus 10 causes the transport controller 82 to control the transport path 40 so as to transport the banknote and the cash voucher to the depositing/dispensing mechanism 22 (Step S718), and to control the inlet/outlet 21 so as to open the shutter (Step S719).

The banknote handling apparatus 10 causes the transport controller 82 to monitor the inside of the depositing/dispensing mechanism 22 (Step S720). When the inside of the depositing/dispensing mechanism 22 is empty (YES at Step S720), the transport controller 82 is caused to control the inlet/outlet 21 so as to close the shutter (Step S721). Thereafter, when the paper sheet is held inside the escrow unit 24 (YES at Step S722), the transport controller 82 is caused to control the escrow unit 24 so as to feed the paper sheet held therein to the transport path 40 (Step S723). The banknote handling apparatus 10 causes the transport controller 82 to control the transport path 40 so as to transport the fed paper sheet (rejected note of the banknote or of the cash voucher) to the recognition/determination mechanism 23 (Step S724). The banknote handling apparatus 10 causes the recognition/determination mechanism controller 84 to control the recognition/determination mechanism 23 to recognize banknotes and cash vouchers (Step S725). When they are the genuine notes (NO at Step S726), the transport controller 82 is caused to control the transport path 40 so as to transport the banknotes to corresponding general-purpose storages 32a to 32e, respectively (Step S728). If they are the rejected notes as a result of recognition (YES at Step S726), the banknote handling apparatus 10 causes the transport controller 82 to control the transport path 40 so as to transport the banknotes and the cash vouchers to the collection storage 31 (Step S727), and ends the process.

Furthermore, as shown in FIG. 8, when the input unit 50 accepts a change request for setting (YES at Step S801), the banknote handling apparatus 10 outputs information for generating an image from the storage setting processor 85 to the output unit 60, to thereby display the image on the screen of the output unit 60 (Step S802).

When the input unit 50 accepts a change instruction for setting of a general-purpose storage and receives setting information (YES at Step S803), the banknote handling apparatus 10 causes the storage setting processor 85 to update the stored paper-sheet-table storage unit 73 (Step S804), and ends the process.

Although the controls for the components upon payment of the money are explained in the embodiment, the banknote handling apparatus according to the present invention controls relevant components when a banknote is deposited.

### Effect of First Embodiment

As explained above, according to the first embodiment, there are provided the general-purpose storages that store therein either one of a banknote or a cash voucher respectively based on the structure capable of storing therein and feeding therefrom both the banknote and the cash voucher; the depositing/dispensing mechanism that holds the cash voucher so that the user can take out the cash voucher; the transport path for transporting both the banknote and the cash voucher from the general-purpose storages to the depositing/dispensing mechanism; and the recognition/determination mechanism that recognizes each type of both the banknote and the cash voucher fed from the general-purpose storages. The cash-voucher setting information indicating in which of the general-purpose storages the cash voucher is stored is accepted and stored. When the cash voucher is to be dispensed, the relevant components are controlled so that the storage corresponding to the stored cash-voucher setting information feeds the cash voucher, the transport path transports the cash voucher while being recognized by the recognition/determination mechanism, and the depositing/dispensing mechanism holds the cash voucher. Thus, the cost of its manufacture can be reduced and the size can be made compact, and the changes to specification can also be flexibly dealt with. In other words, there is no need to provide the storage only for cash vouchers, the recognition/determination mechanism only for cash vouchers, or the transport path only for cash vouchers, and thus, each of the components can be formed with necessary minimum units, which enables the cost of its manufacture to be reduced and the size to be made compact. Furthermore, by only setting the general-purpose storage as one only for cash vouchers, the components are controlled so that the banknote and the cash voucher are recognized as the banknote and as the cash voucher respectively by the same recognition/determination mechanism while being transported through the same transport path, so that it is possible to flexibly deal with the case in which the cash voucher is newly handled. In addition, when the handling of the cash voucher is stopped, the setting of the storage only for the cash voucher is simply released, thus, flexibly dealing with this case.

According to the first embodiment, both the banknote and the cash voucher are held by the depositing/dispensing mechanism so that the user can take out the banknote and the cash voucher. When both the banknote and the cash voucher are to be dispensed, the depositing/dispensing mechanism is controlled so as to hold the cash voucher together with the banknote, and thus, forgetting about taking the cash voucher can be prevented. In other words, it is possible to prevent the case in which, for example, when the banknote is first dispensed, the user takes out only the banknote but forgets to take out the cash voucher without noticing the cash voucher dispensed afterward.

According to the first embodiment, the feature quantities of banknotes and cash vouchers respectively stored in the general-purpose storages are stored, a feature quantity of an object fed from a storage is checked against the stored feature quantity, and it is recognized whether the object fed from the general-purpose storage is the banknote, the cash voucher, or anything other than these, which allows commonality of a recognition method between the banknote and the cash voucher, thus avoiding the recognition process from being complicated.

According to the first embodiment, the amount of cash voucher to be dispensed is stored together with a banknote, corresponding to the money amount of the banknote to be dispensed to the user. When the cash voucher is to be dispensed together with the banknote, the amount of cash voucher corresponding to the money amount of the banknote is read from the stored correspondence relation, and the cash voucher for the corresponding money amount is fed out. Therefore, for example, the user who takes an amount of more money out of the apparatus can take out more cash vouchers.

### Second Embodiment

Although the embodiment of the present invention is explained so far, the present invention may be executed in various different embodiments other than the embodiment. Therefore, different embodiments will be explained by dividing the followings into (1) to (6) as explained below.

(1) Order of Cash Voucher and Banknote

In the first embodiment, the case in which the cash voucher is first stacked in the temporary stacking unit 25 and is first transported to the inside of the depositing/dispensing mechanism 22 is explained, however, the present invention is not limited thereto. Which of the cash voucher and the banknote may be selected to be first stacked in the depositing/dispensing mechanism 22.

This case will be explained below. The banknote handling apparatus 10 accepts and stores therein transport setting information indicating which of a banknote and a cash voucher is to be first transported to the depositing/dispensing mechanism 22 when the cash voucher is to be dispensed together with the banknote. When the cash voucher is to be dispensed together with the banknote, the transport path is controlled according to the stored transport setting information so as to first transport either one of the banknote and the cash voucher to the takeout port.

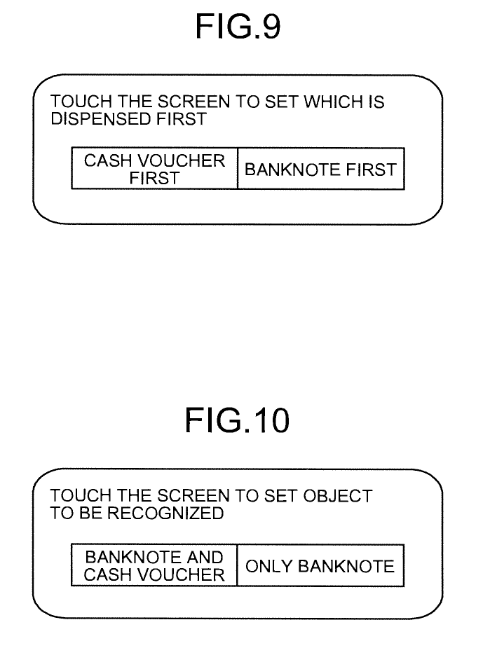

More specifically, as shown in FIG. 9, the banknote handling apparatus 10 displays an image on the screen provided on the outer surface of the apparatus, the image being displayed for accepting setting which of the banknote and the cash voucher is dispensed first. The banknote handling apparatus 10 stores the setting information accepted by the input unit 50 in response to the manager touching the touch panel provided on the outer surface, in the storage unit 70. When accepting a payment request from the user, the banknote handling apparatus 10 reads the stored setting information from the storage unit 70, controls relevant components so as to first dispense the cash voucher if the setting indicates that the cash voucher is dispensed first, and controls relevant components so as to first dispense the banknote if the setting indicates that the banknote is dispensed first. FIG. 9 is a diagram representing an example of the image displayed on the screen of the output unit when the setting related to the dispensing order is accepted. By doing so, for example, by placing the cash voucher on a bundle of notes, this enables the user to see the cash voucher first.

(2) Recognition/Determination of Cash Voucher

In the first embodiment, whether the cash voucher, in addition to the banknote, is recognized as the genuine note or the rejected note is explained, however, the present invention is not limited thereto. An object to be recognized may be specified only to the banknote.

This case will be explained below. The banknote handling apparatus 10 accepts and stores therein recognition setting information indicating whether a recognition function performed by the recognition/determination mechanism 23 is enabled or disabled when the cash voucher is to be dispensed. The recognition/determination mechanism 23 is controlled so as to recognize the cash voucher fed by the storage only when the setting information indicating the recognition function is enabled is stored.

More specifically, as shown in FIG. 10, the banknote handling apparatus 10 displays an image on the screen provided on the outer surface of the apparatus, the image being displayed for accepting setting whether both the banknote and the cash voucher are set as objects to be recognized or only the banknote is set as an object to be recognized. The banknote handling apparatus 10 stores the setting information accepted by the input unit 50 in response to the manager touching the touch panel provided on the outer surface, in the storage unit 70. When accepting a payment request from the user, the banknote handling apparatus 10 reads the stored setting information from the storage unit 70, controls relevant components so as to recognize both the banknote and the cash voucher if the setting indicates that the banknote and the cash voucher are set as objects to be recognized, and controls relevant components so as to recognize only the banknote if the setting indicates that only the banknote is set as an object to be recognized. FIG. 10 is a diagram representing an example of the image displayed on the screen of the output unit when the setting related to the object to be recognized is accepted. By doing so, this enables the banknote and the cash voucher to be dispensed by reducing the processing time by the time consumed for recognition of the cash voucher.

(3) Recognition Method

In the first embodiment, the case in which the respective feature quantities of the banknote and the cash voucher are recognized based on the recognition/determination reference storage unit 72 that stores therein the feature quantities in the form of the common table is explained. However, the present invention is not limited thereto, and thus, any recognition method may be used if the banknote and the cash voucher can be recognized by a single recognition/determination mechanism 23. For example, the feature quantity of the banknote and the feature quantity of the cash voucher may be stored in separate tables respectively. In this case, the transport controller 82 desirably adds an instruction to refer to either one of the banknote and the cash voucher, to the respective feature quantities, when a signal indicating a start of controlling the recognition/determination mechanism 23 is output to the recognition/determination mechanism controller 84.

(4) Simultaneity of Dispensing

In the first embodiment, the case in which the cash voucher are held together with the banknote inside the depositing/dispensing mechanism 22 when the shutter of the inlet/outlet 21 is opened is explained, however, the present invention is not limited thereto. For example, it may be configured to stack only the cash vouchers inside the depositing/dispensing mechanism 22 and open the shutter of the inlet/outlet 21, close the shutter of the inlet/outlet 21 when the user takes out the cash voucher, and next, accumulate only the banknotes inside the depositing/dispensing mechanism 22 and again open the shutter of the inlet/outlet 21.

(5) Replenishment of Cash Voucher

In the first embodiment, the case in which the cash vouchers are previously stored in the general-purpose storage set as a storage for storing therein cash vouchers is explained, however, the present invention is not limited thereto. The cash vouchers may be replenished through a predetermined operation or work. For example, when cash vouchers for replenishment are held in the depositing/dispensing mechanism 22 through a replenishment operation by the manager, the banknote handling apparatus 10 may cause the transport controller 82 to control the transport path 40 so as to transport the cash vouchers for replenishment to the general-purpose storage set as a storage for storing therein the cash voucher. With these processes, the cash vouchers can be replenished with a simple operation as compared with a method for removing the general-purpose storage and replenishing the cash vouchers thereinto.

The general-purpose storage is removably attached to the banknote handling apparatus 10, so that the cash vouchers for replenishment may be received and stored in the general-purpose storage when the general-purpose storage is removed from the banknote handling apparatus 10. With these processes, the cash vouchers can be surely replenished as compared with a method for replenishing the cash vouchers through the inlet/outlet.

(6) System Configuration or the Like

The components of the shown devices are functionally conceptual, and thus they are not necessarily the same as physically shown ones. More specifically, specific formation of dispersion and integration of the devices is not necessarily limited to the shown ones. The components can be configured by functionally or physically dispersing or integrating the entire or part of the components by arbitrary units according to various loads and use patterns, for example, by integrating the cash-voucher dispensed-amount determining unit 81 with the transport controller 82. Furthermore, the entire or arbitrary part of the processing functions performed by the devices are implemented by CPU and by programs analyzed and executed by the CPU, or can be implemented as hardware based on wired logic.

### INDUSTRIAL APPLICABILITY

As explained above, the banknote handling apparatus according to the present invention is useful for dispensing the banknote and also dispensing the cash voucher to the user, is suitable for reducing the manufacturing cost and making the size compact, and is suitable for flexibly dealing with changes to specification.

1. A banknote handling apparatus for dispensing a banknote and dispensing a cash voucher to a user, the banknote handling apparatus comprising:
a plurality of storages that has a structure capable of storing therein and feeding therefrom both the banknote and the cash voucher, and stores therein either the banknote or the cash voucher, respectively;
a cash-voucher-setting-information storage unit that accepts and stores therein cash-voucher setting information indicating in which of the plurality of storages the cash voucher is stored;
a holding unit for take-out that holds the cash voucher so that the user can take out the cash voucher therefrom;
a transport unit that transports both the banknote and the cash voucher from the plurality of storages to the holding unit for take-out;
a recognition unit that recognizes each type of the banknote and the cash voucher fed from the plurality of storages; and
a control unit that controls the respective units so that any one of the storages corresponding to the cash-voucher setting information stored in the cash-voucher-setting-information storage unit feeds a cash voucher when the cash voucher is to be dispensed, the transport unit transports the cash voucher while the recognition unit recognizes the cash voucher, and the holding unit for take-out holds the cash voucher.

2. The banknote handling apparatus according to claim 1, wherein the holding unit for take-out holds both the banknote and the cash voucher so that the user can take out the banknote and the cash voucher, and
the control unit controls, when the cash voucher is to be dispensed together with the banknote, the holding unit for take-out so as to hold the cash voucher together with the banknote.

3. The banknote handling apparatus according to claim 2, further comprising a transport-setting-information storage unit that accepts and stores therein transport setting information indicating which of the banknote and the cash voucher is transported first to the holding unit for take-out when the cash voucher is to be dispensed together with the banknote, wherein
the control unit controls, when the cash voucher is to be dispensed together with the banknote, the transport unit so as to first transport either the banknote or the cash voucher to the holding unit for take-out according to the transport setting information stored in the transport-setting-information storage unit.

4. The banknote handling apparatus according to claim 1, further comprising a recognition-setting-information storage unit that accepts and stores therein recognition setting information indicating whether a recognition function performed by the recognition unit is enabled or disabled when the cash voucher is to be dispensed, wherein
the control unit controls the recognition unit so as to recognize a cash voucher fed by the storage if the recognition setting information indicating that the recognition function is enabled is stored by the recognition-setting-information storage unit.

5. The banknote handling apparatus according to claim 1, further comprising a feature-quantity storage unit that stores therein each feature quantity of the banknote and the cash voucher stored in the plurality of storage unit respectively, wherein
the recognition unit checks a feature quantity of an object fed from the storage against the feature quantity stored in the feature-quantity storage unit, and recognizes whether the object fed from the storage is the banknote, the cash voucher, or anything other than these.

6. The banknote handling apparatus according to claim 1, further comprising a money-amount-information storage unit that stores therein an amount of cash voucher to be dispensed together with a banknote, corresponding to a money amount of the banknote to be dispensed to the user, wherein
the control unit controls, when the cash voucher is to be dispensed together with the banknote, the storage so as to read the amount of the cash voucher corresponding to the money amount of the banknote from the money-amount-information storage unit, and feeds the cash voucher corresponding to the money amount.

7. The banknote handling apparatus according to claim 1, wherein
the transport path transports the banknote and the cash voucher from the plurality of storages to the holding unit for take-out and also transports both of them from the holding unit for take-out to the plurality of storages, and
the control unit controls, when cash vouchers for replenishment are held by the holding unit for take-out, the transport unit so as to transport the cash vouchers for replenishment to the storage corresponding to the cash-voucher setting information stored in the cash-voucher-setting-information storage unit.

8. The banknote handling apparatus according to claim 1, wherein the storage is removably attached to the banknote handling apparatus, so that cash vouchers for replenishment are received and stored in the storage when the storage is removed from the banknote handling apparatus.
